(19) United States
(12) Patent Application Publication
(10) Pub. No.: US 2025/0068638 A1
(43) Pub. Date: Feb. 27, 2025

(54) SEARCHING AND NAVIGATING VIEWING RESULTS

(71) Applicant: ImageScan, Inc., Pasadena, CA (US)

(72) Inventors: Basker S. Krishnan, San Marino, CA (US); Vignesh Gurumurthy, Monrovia, CA (US)

(73) Assignee: ImageScan, Inc., Pasadena, CA (US)

(21) Appl. No.: 18/810,309

(22) Filed: Aug. 20, 2024

Related U.S. Application Data
(60) Provisional application No. 63/578,320, filed on Aug. 23, 2023.

(51) Int. Cl. G06F 16/248

(52) U.S. Cl. CPC G06F 16/248

(57) ABSTRACT

Aspects of the disclosure are directed to searching and navigating viewing results. In accordance with one aspect, the disclosure includes defining a first viewing result for the search result, wherein a boundary of the first viewing result is defined; entering a viewing keyword to be identified in the first viewing result; displaying the first viewing result on a viewing screen; and executing a single tab to navigate from the first viewing result to a second viewing result.

### CLAIM OF PRIORITY UNDER 35 U.S.C. § 119

The present application for patent claims priority to Provisional Application No. 63/578,320 entitled “Page Navigation” filed Aug. 23, 2023, and assigned to the assignee hereof and hereby expressly incorporated by reference herein.

### TECHNICAL FIELD

This disclosure relates generally to the field of search and display, and, in particular, to searching and navigating viewing results.

### BACKGROUND

Searching a database for particular documents and/or searching context in a document for particular pages are essential functions in working with large databases. In searching for documents or for pages in a document, sometimes one or more keywords are used in the search. How a document with the requisite keyword(s) is presented may impact how efficiently a searcher may be able to find the document or the section of a document being searched for. Thus, efficient navigation through the content of a search result is desired.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides searching and navigating viewing results. Accordingly, the present disclosure discloses a method for navigating through a search result stored in a non-transitory memory, the method including: defining a first viewing result for the search result, wherein a boundary of the first viewing result is defined; entering a viewing keyword to be identified in the first viewing result; displaying the first viewing result on a viewing screen; and executing a single tab to navigate from the first viewing result to a second viewing result.

In one example, the viewing keyword is also identified in the second viewing result. In one example, the first viewing result includes a first plurality of partial sections of a first written work from the search result. In one example, the second viewing result includes a second plurality of partial sections of a second written work from the search result.

In one example, the method further includes selecting a first search criteria to generate the search result. In one example, the first search criteria is defined by a plurality of keywords consists a first quantity of key words and a second quantity of keywords, wherein the first quantity of key words appear in each written work of the search result and the second quantity of key words does not appear in the each written work. In one example, the first search criteria is defined by a plurality of keywords appearing in an order of appearance in each written work of the search result. In one example, the first search criteria is defined by a plurality of keywords appearing in an order of appearance on a page of each written work of the search result. In one example, the first search criteria is defined by all keywords in a quantity of keywords appearing on a page of each written work of the search result. In one example, the first search criteria is defined by all keywords in a quantity of keywords not appearing in each written work of the search result.

In one example, the method further includes selecting a second search criteria to combine with the first search criteria to generate the search result, wherein the second search criteria is different from the first search criteria. In one example, the boundary of the first viewing result is defined as a page of a written work. In one example, the boundary of the first viewing result is defined as the content of an email or an attachment to the email. In one example, the email includes all email trails.

Another aspect of the disclosure provides a method for navigating through a search result stored in a non-transitory memory, the method including: selecting a first search criteria to generate the search result, wherein the first search criteria includes a quantity of keywords; defining a first viewing result for the search result, wherein a boundary of the first viewing result is defined: entering a viewing keyword to be identified in the first viewing result; displaying the first viewing result on a viewing screen; and executing a single tab to navigate from the first viewing result to a second viewing result.

In one example, at least one of the quantity of keywords appear in each written work of the search result. In one example, the viewing keyword is one of the at least one of the quantity of keywords. In one example, the viewing keyword is not one of the quantity of keywords. In one example, the boundary of the first viewing result is defined as a page of a written work of the search result.

Another aspect of the disclosure provides a non-transitory computer-readable medium storing computer executable code, operable on a device comprising at least one processor and at least one memory coupled to the at least one processor, wherein the at least one processor is configured to implement navigating through a search result stored in a non-transitory memory, the computer executable code including: instructions for causing a computer to define a first viewing result for the search result, wherein a boundary of the first viewing result is defined; instructions for causing the computer to enter a viewing keyword to be identified in the first viewing result; instructions for causing the computer to display the first viewing result on a viewing screen; and instructions for causing the computer to execute a single tab to navigate from the first viewing result to a second viewing result.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example flow diagram for implementing searching and navigating viewing results.

FIG. 2 illustrates an example search and display system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

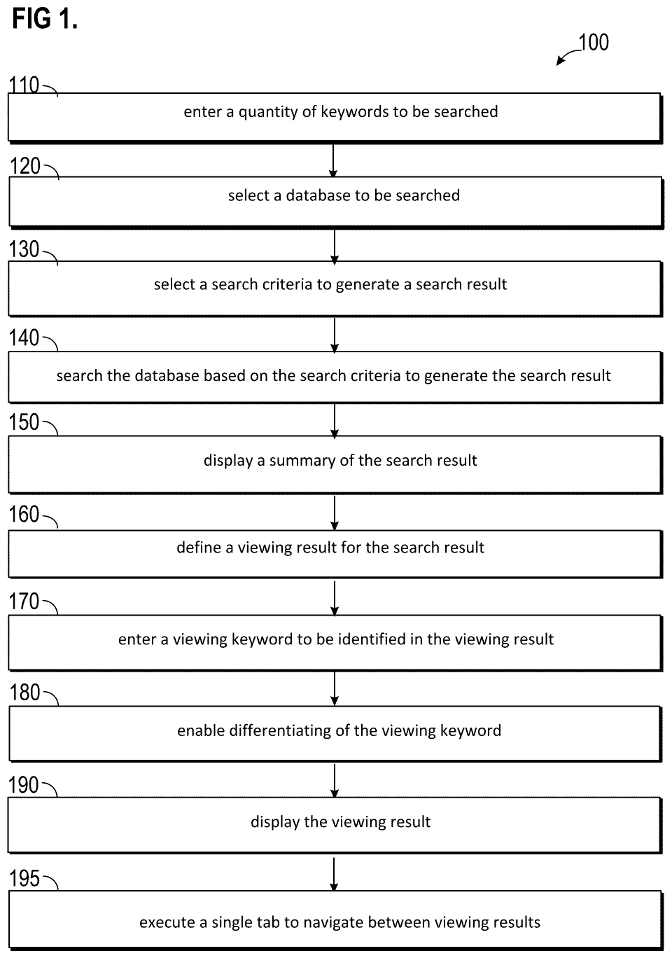

FIG. 1 illustrates an example flow diagram 100 for implementing searching and navigating viewing results. In block 110, enter a quantity of keywords to be searched. For example, the quantity of keywords may be one keyword or multiple keywords. For example, the quantity of keywords may be a single keyword. In the example of multiple keywords, each individual keyword may or may not be related to one another. In one example, a keyword may be a single word, a phrase of multiple words or a non-alphabet image. In one example, a non-alphabet image is, but is not limited to, a visual representation of something, a likeness of an object, a symbol, etc.

In block 120, select a database to be searched. In one example, the database is a repository of written work. In one example, written work may include one or more of the following: written documents, emails and/or attachments to emails. In one example, the database is the plain meaning of the word; that is, the database is a structured set of data held in a computer or processor memory. In one example, the database may include a repository of written documents and/or emails and/or email attachments. In one example, the computer or processor memory is a non-transitory memory.

In block 130, select a search criteria to generate a search result. In one example, the search result may include one or more of the following: one or more written documents, one or more emails, one or more attachments to email(s). Optionally, an attachment may be included in a search result without its associated email. In one example, the search result may be presented in any type of format for presenting written work, such as but not limited to, a Word format, an email format, a pdf format, or a partial presentation of such, etc.

For example, the search criteria may include one or more of the following:
Example A: That all keywords in the quantity of keywords be present in the written work for the written work to be included in the search result.
Example B: That only a subset of keyword(s) in the quantity of keywords be present in the written work while the rest of the quantity of keywords are not present in the written work for the written work to be included in the search result. In one example, the subset of keyword(s) is a particular keyword or the subset of keyword(s) is more than one keyword but less than all the keywords in the quantity of keywords. A subset of keyword(s) may also be described as a subset of the quantity of keywords.
Example C: That all keywords in the quantity of keywords not be present in the written work for the written work to be included in the search result.
Example D: That a particular keyword or more than one keyword in the quantity of keywords be present in a single page of the written work for the written work to be included in the search result. Or, in the case the written work is an email, that a particular keyword or more than one keyword in the quantity of keywords be present in either the body of an email or in an attachment to the email for the email to be included in the search result.
Example E: That particular keywords in the quantity of keywords appear in a particular order of appearance in the written work or on a page of the written work for the written work to be included in the search result. In an example, where the written work is an email, the term “page” may refer to the content of an email body, the content of an email including all email trails, or the content of an attachment to an email.
In one example, to satisfy the particular order of appearance, the keywords only have to appear in that particular order once. That is, for example, if the particular order of appearance is wordA, then wordB, then wordC, then the appearance of keywords in an example order of wordA, then wordB, followed by a second appearance of wordA, then wordC would satisfy the order of appearance because there is an order of wordA, then wordB, then wordC in the example.
Example F: That all keywords in the quantity of keywords be present in at least one page of the written work for the written work to be included in the search result. In an example, where the written work is an email, the term “page” may refer to the content of an email body, the content of an email including all email trails, or the content of an attachment to an email.
   In one example, the quantity of keywords may include a single keyword. In one example, the “page” of the written work is a viewing result as defined in block 160.

In block 140, search the database based on the search criteria to generate the search result. In one example, the search criteria may be modified following a first attempt at searching. In one example, the search criteria may be modified following one or more attempts at searching. For example, if in a first attempt, a first search criteria (e.g., Example A search criteria) is used but following the search, a different search criteria (e.g., Example B search criteria) may be used for the search. This example could be employed if the search result of the first attempt is unsatisfactory.

For example, after a first attempt at searching using a first search criteria (e.g., Example A search criteria) to generate a first search result, a second search on the first search result may be conducted using a different search criteria (e.g., Example C search result) to generate a second search result. One skilled in the art would understand that combination of the different examples of search criteria for a single search are within the scope and spirit of the present disclosure. One skilled in the art would also understand, within the scope and spirit of the present disclosure, a different search criteria or a combination of more than one search criteria may be used for subsequent searches on prior search result(s).

In block 150, display a summary of the search result. In one example, the summary display is a list of names of files in the search result. In one example, the summary display is a list of emails in the search result, wherein the emails may be displayed with some identification (such as, but not limited to, date information, sender information, recipient information, subject information, and/or timing information (such as time sent, time received by one or more recipients, or both time sent and received), etc.). In one example, the summary display includes image(s) that identify files in the search result. For example, the image(s) may be in scaled common image format (CIF). For example, the image(s) may represent initial pages (e.g., cover pages) of written documents or recognizable representative pages of written documents and/or emails, with or without attachment(s). In one example, the step in block 150 is optional. In one example, the search result is simply a database of written work not associated with an a priori search.

In block 160, define a viewing result for the search result. In one example, the viewing result may be defined as a conventional page of a book, a conventional page of a pamphlet, a conventional page of a stack of letter sized papers, a conventional page of a stack of A-4 sized papers or a conventional page of a stack of any sized papers. In one example, the viewing result may be defined as a blown-up view when it is displayed at 100% scale or near 100% scale on a viewing screen. In one example, the viewing result may be defined as a blown-up view when the display is readable to a user looking at the viewing result on the viewing screen. The viewing result is a presentation of the search result. The extent or boundary of the viewing result may be defined by a user who would like to view the search result. Or, in one example, the extent or boundary of the viewing result may be defined by an application of a processing engine associated with a viewing screen.

In one example, the viewing result may be defined as a complete file of a written work in the search result. In one example, the viewing result may be defined as one or more partial sections of a written work in the search result. In all cases, the viewing result includes at least one viewing keyword.

In the example that the viewing result is defined as partial sections of a written work, the user may define the extent or boundary of a partial section in the step of block 160. For example, a partial section could be defined as a conventional page of a written work. For example, a partial section could be defined by a word count. For example, a partial section could be defined by a quantity of paragraphs. For example, if the written work is an email with attachment(s), a first partial section could be defined as the body of the email with subsequent partial sections defined by each subsequent attachment to the email.

For example, a partial section could be defined based on the size of a viewing screen and/or the font size of the content to be viewed. One skilled in the art would understand that the examples herein on defining the extent or boundary of a partial section are not exclusive and other definitions for the extent or boundary of a partial section are also within the scope and spirit of the present disclosure.

In the example of a written document, if the viewing result is defined as a complete file, than the viewing result is the entirety of the written document (i.e., all the pages of the written document). And, in this example, the entirety of the written document is available for viewing on the viewing screen without requiring further action by a user (other than scrolling through the viewing screen). In this example, the viewing result is the entire written document, or stated alternatively, the entire written document is the viewing result. If the entire document's content does not fit on the viewing screen, then scrolling will be needed to view the entire viewing result. And, in one example, the execution of a single tab (as disclosed in block 195) will cause the next written document to be presented as the next viewing result on the viewing screen.

In another example of an email without attachment(s), if the viewing result is defined as a complete file, than the viewing result is all the content of the email (i.e., an email and/or its entire email trail). And, in this example, all the content of the email (i.e., an email and/or its entire email trail) is available for viewing on the viewing screen without requiring further action by a user (other than scrolling through the viewing screen).

In another example of an email with attachment(s), if the viewing result is defined as a complete file, than the viewing result is all the content of the email (i.e., an email and/or its entire email trail) and all the attachments. And, in this example, all the content of the email (i.e., an email and/or its entire email trail) and all the attachments are available for viewing on the viewing screen without requiring further action by a user (other than scrolling through the viewing screen).

In one example, the viewing result displays all keywords in the quantity of keywords in the written work and includes differentiation(s) to the keywords from other non-keywords. In another example, the viewing result displays one or more selected keywords in the quantity of keywords in the written work and includes differentiation(s) to the selected keywords from other non-keywords and from other non-selected keywords in the quantity of keywords. A user, for example, may define which keyword(s) should include the differentiation. In one example, all viewing keywords include differentiation. A differentiation may include highlights, different font size, written in a different color, being bolded, being italicized, etc.

In one example, once the viewing result is defined, the defined viewing result may be added to a list of preset viewing results for use on future search results. In one example, the defined viewing result may be set as a default setting for use on future search results. That is, a user may choose a previously defined viewing result or choose to use a viewing result that is the default setting. In one example, the user may choose to define a viewing result for an upcoming search result. The choice of the viewing result may be chosen prior to conducting a search. Or, the choice of the viewing result may be chosen after a search has commenced but before a search result is presented to the user. In another alternative, a new choice of a new viewing result may be chosen per user discretion if the existing viewing result is not satisfactory. In one example, satisfaction of a viewing result may be subjective to an user.

In one aspect, in accordance with block 160, a user may define the extent or the boundary of a viewing result of a written work in a search result.

In block 170, enter a viewing keyword to be identified in the viewing result. A viewing keyword is a keyword that must appear in the viewing result. In one example, the viewing keyword is a keyword in the quantity of keywords used in the search. In another example, the viewing keyword is a new keyword that is not part of the quantity of keywords used in the search. In one example, there may be multiple viewing keywords. In one example, the viewing keyword may be a single word, a phrase of multiple words or a non-alphabet image. In one example, a non-alphabet image is, but is not limited to, a visual representation of something, a likeness of an object, a symbol, etc.

In one example, the step in block 170 is optional. In the example that the step in block 170 is not executed, then the keyword(s) that appear in the written work (as defined by the search criteria in block 130) is considered the viewing keyword(s).

In one example, the viewing keyword is a single keyword or a single non-alphabet image. In another example, the viewing keyword includes multiple keywords, or multiple non-alphabet images. In the example, that a viewing keyword is identified, a written work (e.g., a document, an email, an attachment to an email, etc.) in a search result would have within it the quantity of keywords, but the presentation of the written work would only differentiate the viewing keyword in the written work. For example, if the quantity of keyword is “apple”, “orange”, “banana” and “fruit”, but the viewing keyword is “apple”, then the written work in the search result would include “apple”, “orange”, “banana” and “fruit”, but only “apple” may be differentiated in the written work when presented and only “apple” needs to appear in the viewing result.

In block 180, enable differentiating of the viewing keyword. In one example, differentiating the viewing keyword means that the viewing keyword is presented differently than the rest of the content of the viewing result in the viewing screen. For example, the viewing keyword may be highlighted, presented in a different font size, written in a different color, bolded, italicized, etc. In the example that the step in block 170 is not executed, then all the keywords that appear in the written work may be differentiated from the rest of the content in the viewing result. In one example, the step in block 180 is optional.

In block 190, display the viewing result. In one example, wherein the viewing result spans beyond the viewing screen, the user only needs to scroll to view the entire viewing result. And, all the viewing keywords are shown in the viewing result.

In block 195, execute a single tab to navigate between viewing results. In a first example, the viewing results are confined to a single written work of the search result. In a second example, the viewing results include the content of multiple written work of the search result. A user may define whether the viewing result is the first example or the second example for each search.

In one example, each time the single tab is executed, a different viewing result is presented. That is, each time the single tab is executed, a next viewing result which includes the viewing keyword is displayed on the viewing screen. For example, if the viewing result is defined as a conventional page of a written document, but the viewing screen can only display half a page at a time, and the viewing keyword appears both on the first half of the page and the second half of the page, then if the first half of the page is displayed on the viewing screen, scrolling can display more of the page to include the second half of the page. However, if the first half of the page is displayed on the viewing screen, and the single tab is executed, the next presentation on the viewing screen is the next viewing result which, in this example, is the first half of next page of the written work with the viewing keyword.

In one example, the single tab may be a single tap, a single click or a single touch of the viewing screen.

In one example, although the viewing keyword(s) may appear in multiple places on a viewing result, the execution of the single tab will skip over the rest of the appearances of the viewing keyword(s) on the viewing result and present the next viewing result where the viewing keyword(s) appears.

In one example, in the context of an email with attachments, the execution of the single tab will cause the presentation of a first attachment that includes the viewing keyword(s), and a second execution of the single tab will cause the presentation of the next attachment with the viewing keyword(s), etc. Thus, in one example. If the entire context of the first attachment does not fit a viewing screen (is not visible without scrolling), and there is an execution of the single tab, the next presentation on the viewing screen is the context of the second attachment, and any viewing keyword(s) in the first attachment not shown in the viewing screen will be skipped (not presented).

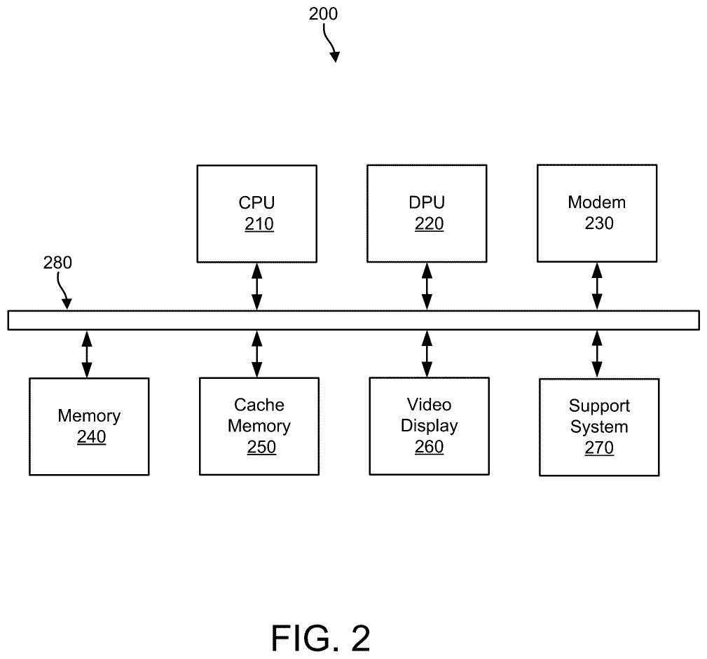

In one example, the example flow diagram of FIG. 1 may be implemented by a search and display system. FIG. 2 illustrates an example search and display system 200. For example, the search and display system may include multiple slices (e.g., circuit modules). In one example, a slice may include one or more processing engines and/or one or more memory units and/or other peripheral devices. In one example, a slice may include one or more systems on a chip (SoC).

In one example, the search and display system 200 includes one or more processing engines such as a central processing unit (CPU) 210 and/or a display processing unit (DPU) 220 In one example, the search and display system 200 may include a modem 230, a memory 240, a cache memory 250 and a video display 260 and a support system 270 (e.g., power supply system, printer, scanner, copier, camera, microphone, audio equipment, etc.) In one example, the various components of the search and display system 200 are interconnected by an interconnection databus 280 to transport data and control information.

For example, the memory 240 and/or the cache memory 250 may be shared among the CPU 210 and the DPU 220. In one example, the CPU 210 and/or the DPU 220 may each include an internal memory which is not shared with the other processing engine. Although several components of the search and display system 200 are included herein, one skilled in the art would understand that the components listed herein are examples and are not exclusive. Thus, within the spirit and scope of the present disclosure, other components may be included as part of the search and display system 200.

In one example, the search and display system 200 may be a wireless device and may conform to any existing wireless network protocol at use. In one example, the search and display system 200 may include a network interface card (NIC) to ingest data packets from a network and to send data packets to the network. The NIC complies with any existing network protocols at use. In one example, the NIC may interface with the modem 230 to interconnect to an external network. In one example, the memory disclosed herein is a non-transitory memory.

In one aspect, one or more of the steps for providing searching and navigating viewing results in FIG. 1 may be executed by one or more processors which may include hardware, software, firmware, etc. The one or more processors, for example, may be used to execute software or firmware needed to perform the steps in the flow diagram of FIG. 1. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method for navigating through a search result stored in a non-transitory memory, the method comprising:
defining a first viewing result for the search result, wherein a boundary of the first viewing result is defined;
entering a viewing keyword to be identified in the first viewing result;
displaying the first viewing result on a viewing screen; and
executing a single tab to navigate from the first viewing result to a second viewing result.

2. The method of claim 1, wherein the viewing keyword is also identified in the second viewing result.

3. The method of claim 2, wherein the first viewing result includes a first plurality of partial sections of a first written work from the search result.

4. The method of claim 3, wherein the second viewing result includes a second plurality of partial sections of a second written work from the search result.

5. The method of claim 2, further comprising selecting a first search criteria to generate the search result.

6. The method of claim 5, wherein the first search criteria is defined by a plurality of keywords consists a first quantity of key words and a second quantity of keywords, wherein the first quantity of key words appear in each written work of the search result and the second quantity of key words does not appear in the each written work.

7. The method of claim 5, wherein the first search criteria is defined by a plurality of keywords appearing in an order of appearance in each written work of the search result.

8. The method of claim 5, wherein the first search criteria is defined by a plurality of keywords appearing in an order of appearance on a page of each written work of the search result.

9. The method of claim 5, wherein the first search criteria is defined by all keywords in a quantity of keywords appearing on a page of each written work of the search result.

10. The method of claim 5, wherein the first search criteria is defined by all keywords in a quantity of keywords not appearing in each written work of the search result.

11. The method of claim 5, further comprising selecting a second search criteria to combine with the first search criteria to generate the search result, wherein the second search criteria is different from the first search criteria.

12. The method of claim 1, wherein the boundary of the first viewing result is defined as a page of a written work.

13. The method of claim 1, wherein the boundary of the first viewing result is defined as the content of an email or an attachment to the email.

14. The method of claim 13, wherein the email includes all email trails.

15. A method for navigating through a search result stored in a non-transitory memory, the method comprising:
selecting a first search criteria to generate the search result, wherein the first search criteria includes a quantity of keywords;
defining a first viewing result for the search result, wherein a boundary of the first viewing result is defined;
entering a viewing keyword to be identified in the first viewing result;
displaying the first viewing result on a viewing screen; and
executing a single tab to navigate from the first viewing result to a second viewing result.

16. The method of claim 15, wherein at least one of the quantity of keywords appear in each written work of the search result.

17. The method of claim 16, wherein the viewing keyword is one of the at least one of the quantity of keywords.

18. The method of claim 16, wherein the viewing keyword is not one of the quantity of keywords.

19. The method of claim 15, wherein the boundary of the first viewing result is defined as a page of a written work of the search result.

20. A non-transitory computer-readable medium storing computer executable code, operable on a device comprising at least one processor and at least one memory coupled to the at least one processor, wherein the at least one processor is configured to implement navigating through a search result stored in a non-transitory memory, the computer executable code comprising:
instructions for causing a computer to define a first viewing result for the search result, wherein a boundary of the first viewing result is defined;
instructions for causing the computer to enter a viewing keyword to be identified in the first viewing result;
instructions for causing the computer to display the first viewing result on a viewing screen; and
instructions for causing the computer to execute a single tab to navigate from the first viewing result to a second viewing result.
